(19) United States
(12) Patent Application Publication
(10) Pub. No.: US 2015/0080079 A1
(43) Pub. Date: Mar. 19, 2015

(54) VIDEO POKER GAME WITH FOLD'EM OPTION AND METHOD THEREFOR

(71) Applicant: STEPHEN M. HARRIS, HENDERSON, NV (US)

(72) Inventor: STEPHEN M. HARRIS, HENDERSON, NV (US)

(21) Appl. No.: 14/029,399

(22) Filed: Sep. 17, 2013

(51) Int. Cl. G07F 17/32

(52) U.S. Cl. CPC G07F 17/3293
USPC 463/13

(57) ABSTRACT

A method for playing a video poker game comprising: placing a wager to begin play by a participating player; dealing five cards to the participating player face up from a standard 52 card deck for the participating player, wherein the participating player may one of: hold, fold, or replace any of the five cards; and returning a portion of the wager if the participating player decides to fold.

### REFERENCE TO RELATED APPLICATIONS

This disclosure claims priority to U.S. Provisional Application Ser. No. 61/701,863 titled “Video Poker With Fold'em Option” that was filed on Sep. 17, 2012 by Steve Harris and Lawrence Vaughn, which is hereby incorporated by reference in its entirety.

### TECHNICAL FIELD

This disclosure generally relates to a poker game, and more particularly, to a video poker game wherein a player has an option to fold their hand and limit their losses if the first five cards dealt fail to make a winning poker hand or fail to have a high probability of making a winning poker hand.

### BACKGROUND

The card game of poker, with its many variations, has become an extremely popular form of entertainment. Poker is now a common social pastime for both gamblers and non-gamblers. One popular form of poker is video poker. Video poker is a video game based on five-card draw poker. It is generally played on a computerized console similar in size to a slot machine. In general, each player plays a hand against the house. The player's hand is generally compared to a payout schedule located on the computerized console. If the player has a winning hand based on the payout schedule, the player wins and the house make the indicated payout. If the player has a losing hand based on the payout schedule, the house keeps the wager made by the player.

Presently, video poker games fail to give the player an option to limit their losses after revealing the first five cards of their poker hand. It is therefore, desirable that a player would like to have the option to fold their hand and limit their losses if the first five cards fail to make a winning poker hand or fail to have a high probability of making a winning poker hand

Therefore, it would be desirable to provide a card game and method that overcomes the above problems.

### SUMMARY

This summary is provided to introduce a selection of concepts in a simplified form that are further described below in the DESCRIPTION OF THE DISCLOSURE. This summary is not intended to identify key features of the claimed subject matter, nor is it intended to be used as an aid in determining the scope of the claimed subject matter.

A computer implemented video poker card game, the computer comprising a visual display device and a processor operably coupled to the display device and combined to display a card game, the processor programmed for a method comprising: placing a wager to begin play by a participating player; dealing five cards to the participating player face up from a standard 52 card deck for the participating player, wherein the participating player may one of: hold, fold, or replace any of the five cards; and returning a portion of the wager if the participating player decides to fold.

A game server comprising: at least one processor; and a memory operatively coupled to the at least one processor, the memory storing program instructions that when executed by the at least one processor causes the at least one processor to perform a method comprising: placing a wager to begin play by a participating player; dealing five cards to the participating player face up from a standard 52 card deck for the participating player, wherein the participating player may one of: hold, fold, or replace any of the five cards; and returning a portion of the wager if the participating player decides to fold.

A method for playing a video poker game comprising: placing a wager to begin play by a participating player; dealing five cards to the participating player face up from a standard 52 card deck for the participating player, wherein the participating player may one of hold, fold, or replace any of the five cards; and returning a portion of the wager if the participating player decides to fold.

The features, functions, and advantages can be achieved independently in various embodiments of the disclosure or may be combined in yet other embodiments.

### BRIEF DESCRIPTION OF DRAWINGS

The novel features believed to be characteristic of the disclosure are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a functional block diagram of the video poker system of the present invention;

FIG. 2 is a front view of a video poker console; and

FIG. 3 is a functional block diagram of another embodiment of the video poker system of the present invention; and

FIG. 4 is a flow chart showing a method of playing the video poker game of the present invention.

### DESCRIPTION OF THE DISCLOSURE

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

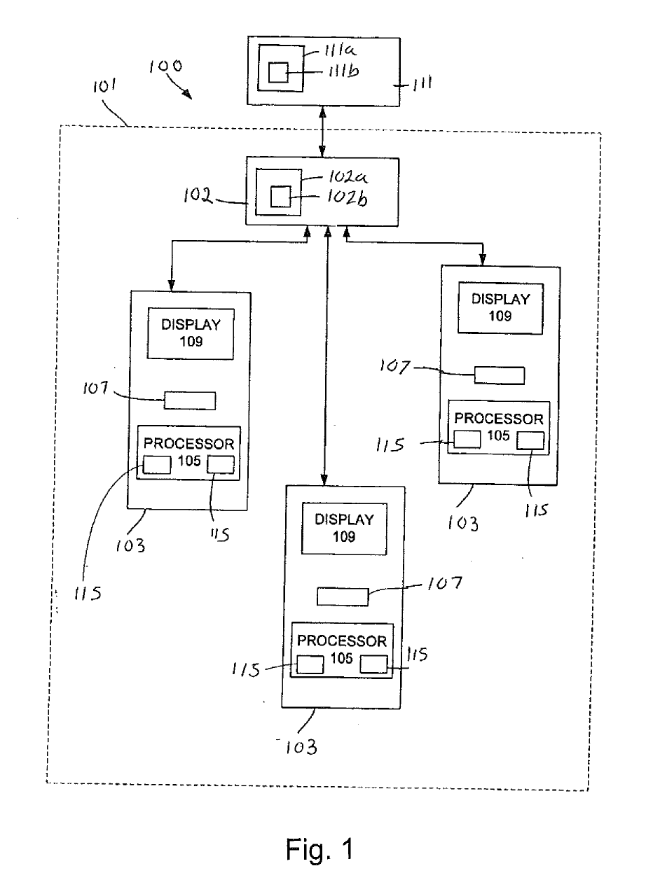

Referring to FIG. 1, a gaming system 100 for implementing the present invention is shown. The system 100 allows a player to play a video poker game against the house where the player makes a wager and receives a plurality of cards. Once the player receives his/her cards, the player will have the option to fold the hand and receive a portion of their wager back or continue to play.

The system 100 may run on a gaming unit 103 or on a gaming system 101 running on a single gaming site/casino 105. Alternatively, the system 100 may run across multiple gaming sites/casinos 105. If the system 100 is run at a single gaming site/casino 101, the system 100 may include a local area server 102. The local area server 102 may be used to run the game on a plurality of gaming units 103. Alternatively, if multiple gaming sites 101 are included in the system 100, the system 100 may also include a central game server 111 to allow system wide communications, data collection, and control between or among gaming sites 101. The local area server 102 and the central game server 111 each include a processor 102a and 111a respectively. The processors 102a and 111a may be associated with memory 102b and 111b respectively which may be non-volatile memory, volatile memory, and/or both. The volatile and/or nonvolatile memory 102b and 111b may store computer program code that is executed by the processors 102b and 111b respectively to cause the processor to perform or direct the various functions for the gaming unit 103.

Each gaming unit 103 may include a processor 105 and a user interface arrangement including a player control arrangement 107 and a display device 109. The processor 105 may be associated with memory 115 which may be non-volatile memory, volatile memory, and/or both. The volatile and/or nonvolatile memory 115 may store computer program code that is executed by the processor 105 to cause the processor to perform or direct the various functions to run the video poker game or as provided by the gaming unit 103. Each gaming unit 103 may further have a player input control 107. The player input control 107 may include various configurations of buttons, switches, pointing devices, and other devices that allow a player to make inputs during the course of a poker game. Display device 109 may include at least one video monitor/display such as a CRT, LCD, plasma, or other display device for displaying graphics in the course of game play. In particular, display device 109 displays various playing card representations as will be described in detail below. It will also be noted that player control functions may be integrated with display device 109 by using a touch screen display device. In these arrangements, the display screen itself, or more specifically, the touch sensitive film applied over the display screen and the controller associated with the touch-sensitive film, comprises part of player control arrangement 107.

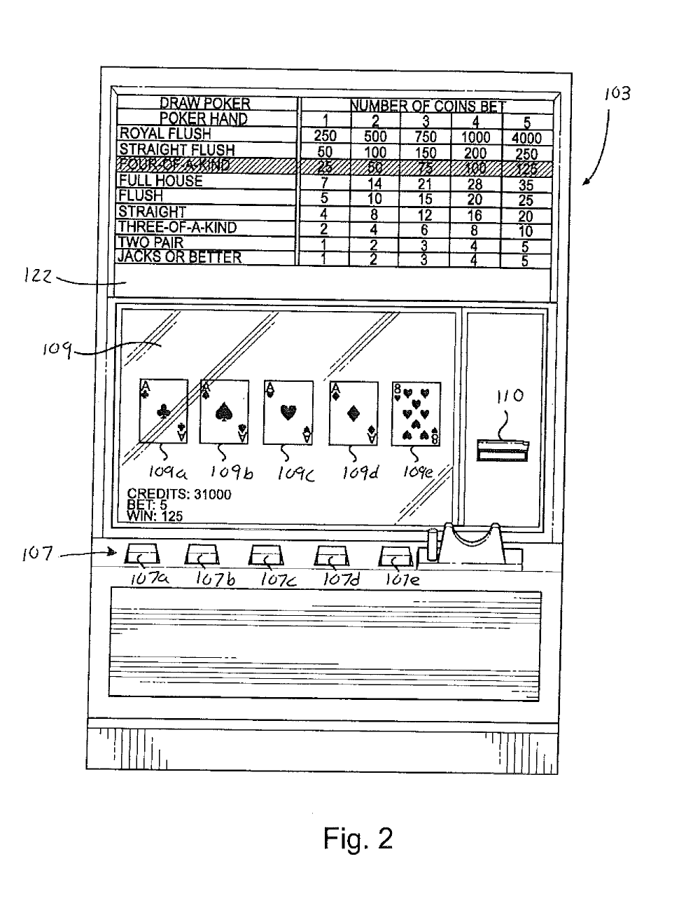

Referring to FIG. 2, one embodiment of a gaming unit 103 is shown, The gaming unit 103 may be used for playing the video poker game of the present invention. The gaming unit 103 may have a display device 109. The display device 109 may be used for displaying cards or other symbols at positions 109a-109e. In the present embodiment, the player input control 107 is a set of buttons 107a-107e. The buttons 107a-107e may be used as input buttons to hold and/or discard the displaying cards or other symbols at positions 109a-109e. As stated above, it should be understood that different inputs may also be used. For example, the display device 109 may be a touch screen and buttons may appear on the display screen under card positions 109a-109e or otherwise proximate to card positions 109a-109e.

The gaming unit 103 may further have a wager/payout device 110 for accepting wagers and making payouts to players. The wager/payout device 110 is typically a note acceptor-dispenser that accepts and validates currency inserted by the player, and for dispensing currency to a player for unused credits that are either unplayed or won during a play session. The wager/payout device 110 may also be configured to print tickets for an amount of credit available to the player when he no longer desires to play the machine.

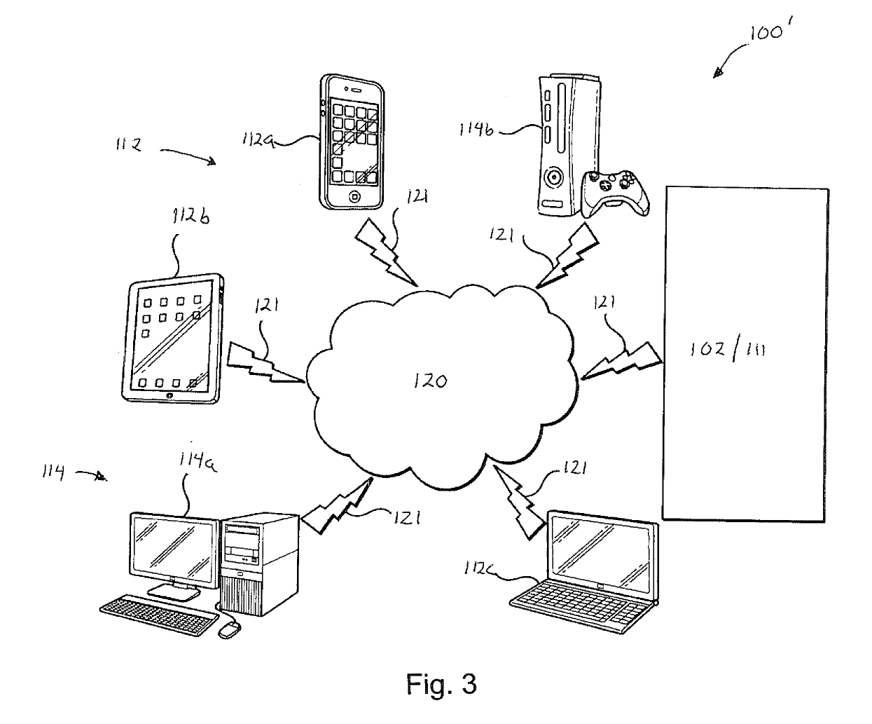

Referring now to FIG. 3, another embodiment of a gaming system 100′ for implementing the present invention is shown. The system 100′ may be comprised of a plurality of mobile device 112. The mobile devices 112 may be a cellular phone 112A, a tablet 112B, a laptop 112C or the like. The system 100′ may have other devices 114. These other devices 114 may include a desktop computer 114A, a gaming console 114B, or the like. The listing of the mobile devices 112 or other devices 114 is given as an example and should not be seen in a limiting manner. The network system 120 may be a local-area network (LAN), wide-area network (WAN) or the Internet. The connection 121 may be a wired connection, a wireless connection, or the like. The mobile devices 112 and/or other devices 114 may then access the local area server 102 or the central game server 111, which ever server may be used for hosting the poker game.

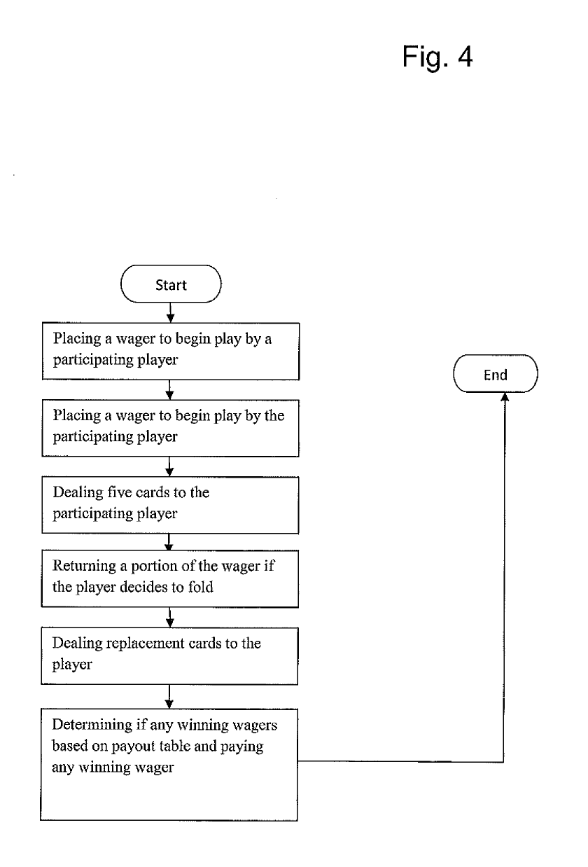

Referring now to FIG. 4, operation of the game will be disclosed. The operation of the game will be disclosed in regards to the system 100 of FIGS. 1 and 2. However, the game may be played on the system 100′ as well. The poker game of the present invention allows players to play individual poker games on the player's respective gaming unit 103. The gaming unit 103 may run the video poker game or alternatively, the poker game may be run on the local area server 102 and/or the central game server Ill to which the gaming unit 103 may be coupled. The poker game of the present invention relates to playing a five card draw video poker game against the house where the player makes a wager and receives five cards face up. Once the player receives the five cards face up, the player will have the option to fold the hand and receive a portion of their wager back. If the player selects this option the game is over and the player receives a portion of their wager back from the game. If the player decides to continue to play and not fold the hand, the player will have the option to hold or discard any of the five cards dealt.

On the gaming unit 103, each player may first enter playable credits by placing currency, player's card etc. into the wager/payout device 110. Once credits have been entered into the gaming unit 103, the participating player may begin playing. The player begins play by the participating player making a wager. Once the wager is placed, the player receives five cards face up from their own 52 card standard deck of cards. The five cards are generally displayed face up on the player's respective display device 109 on the gaming unit 103. Each participating player may then be asked to hold or replace any/all of the five cards to make the best possible poker hand or fold. Each player may use buttons 107a-107e to hold and/or discard respective cards at positions 109a-109e. If a player elects to replace one, two, three, four or five cards, an additional card or cards will be dealt face up to the player to replace each card replaced from their own 52 card deck to form a final hand. If the player elects not to replace any cards the player is opting to play the original five cards dealt as the final hand. If the player decided to fold, the player receives a portion of their wager back from the game.

In one example, the player begins play by wagering five dollars into the game. The player receives five cards face up from a standard 52 card deck and is given the option to fold the hand, thereby ending the game. If the player elects to fold the hand, the player receives $2.50 of their wager back and the game is over. If the player continues playing the game, the player will have the option to hold or discard each of the five cards dealt. After the player decides what cards are going to be held or discarded, the dealer replaces each card discarded from the remaining 52 cards in the deck. If the five cards revealed a Jack of Hearts, Jack of Diamonds, Two of Hearts, Three of Clubs and Six of Spades, and Jacks or Better pays two times the wager, the player would receive ten dollars total back for the winning hand. Therefore, if the five cards reveal a winning poker hand as determined by the pay table 122, the player wins the corresponding amount on the pay table 122. If the five cards revealed do not make a winning hand as determined by the pay table on the machine the player losses their five dollar wager.

The foregoing description is provided to enable any person skilled in the relevant art to practice the various embodiments described herein. Various modifications to these embodiments will be readily apparent to those skilled in the relevant art, and generic principles defined herein can be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A computer implemented video poker card game, the computer comprising a visual display device and a processor operably coupled to the display device and combined to display a card game, the processor programmed for a method comprising:
placing a wager to begin play by a participating player;
dealing five cards to the participating player face up from a standard 52 card deck for the participating player, wherein the participating player may one of hold, fold, or replace any of the five cards; and
returning a portion of the wager if the participating player decides to fold.

2. The method of claim 1, further comprising:
dealing replacement cards to the participating player from the standard 52 card deck for the participating player when the participating player selects to replace any of the five card dealt to that participating player;
determining if the participating players has a winning wager by verifying if remaining five cards of the participating player matches a poker hand stated on a pay table; and
paying the participating player having a winning wager.

3. A game server comprising:
at least one processor; and
a memory operatively coupled to the at least one processor, the memory storing program instructions that when executed by the at least one processor causes the at least one processor to perform a method comprising:
placing a wager to begin play by a participating player;
dealing five cards to the participating player face up from a standard 52 card deck for the participating player, wherein the participating player may one of: hold, fold, or replace any of the five cards; and
returning a portion of the wager if the participating player decides to fold.

4. The method of claim 3, further comprising:
dealing replacement cards to the participating player from the standard 52 card deck for the participating player when the participating player selects to replace any of the five card dealt to that participating player;
determining if the participating players has a winning wager by verifying if remaining five cards of the participating player matches a poker hand stated on a pay table; and
paying the participating player having a winning wager.

5. A method for playing a video poker game comprising:
placing a wager to begin play by a participating player;
dealing five cards to the participating player face up from a standard 52 card deck for the participating player, wherein the participating player may one of: hold, fold, or replace any of the five cards; and
returning a portion of the wager if the participating player decides to fold.

6. The method of claim 5, further comprising:
dealing replacement cards to the participating player from the standard 52 card deck for the participating player when the participating player selects to replace any of the five card dealt to that participating player;
determining if the participating players has a winning wager by verifying if remaining five cards of the participating player matches a poker hand stated on a pay table; and
paying the participating player having a winning wager.
